(19) United States
(12) Patent Application Publication
(10) Pub. No.: US 2008/0303642 A1
(43) Pub. Date: Dec. 11, 2008

(54) Apparatus and Method for Remotely Obtaining and Evaluating Vehicular and Other Information

(76) Inventor: Mark W. Jolley, Carlsbad, CA (US)

Correspondence Address: FITCH EVEN TABIN AND FLANNERY, 120 SOUTH LA SALLE STREET, SUITE 1600, CHICAGO, IL, 60603-3406, US

(21) Appl. No.: 12/048,611

(22) Filed: Mar. 14, 2008

Related U.S. Application Data
(60) Provisional application No. 60/894,830, filed on Mar. 14, 2007.

(51) Int. Cl. G08B 7/06

(52) U.S. Cl. 340/286.01

(57) ABSTRACT

An apparatus and method for remotely obtaining and evaluating vehicular and other information is disclosed, where a field device can be used to wirelessly transmit information to a processor. The processor can compare the information against other information in a database. Based upon the results of the comparison, the results are evaluating by the processor using predetermined criteria and one or more of a plurality of different predetermined instructions are wirelessly transmitted to the field device.

### CROSS-REFERENCE TO RELATED APPLICATION

This application claims priority from U.S. Patent Appl. No. 60/894,830, filed on Mar. 14, 2007, which is hereby incorporated by reference in its entirety.

### FIELD

The apparatus and methods described herein relate generally to apparatus and methods for remotely obtaining vehicular information, and in particular to apparatus and methods for evaluating such vehicular information.

### BACKGROUND

In the environment that we find ourselves in we rely heavily on our law enforcement personnel to serve protect and defend. With threats such as terrorism, it is desirable to arm our law enforcement personnel or officers with the best technology to help them in enforcing current laws and identifying those who pose a threat to others. Currently we rely heavily on the officers to recognize and remember people vehicles places many things. Officers have computers that access data bases but frequently rely on the officer to input data to get back information. This requires the officer to be distracted in an effort to either relay the information over the radio or enter the information into the computer. This also requires time which in many circumstances the officer does not have.

### SUMMARY

The apparatus and methods can be part of an integrated system to help enforce current laws and facilitate quicker feedback to the officer to give him or her an additional tool to use in law enforcement activities and improving the overall security, such as crime prevention. A method is provided herein where a device is constructed and integrated within a system that allows an officer to remotely obtain vehicular information, such as by using photographic or videographic cameras. The field device may be hand held, removably or permanently mounted in a law enforcement vehicle, or the like. The information obtained can, such as by using wireless technology, be compared with a data base of information to evaluate the vehicle. This advantageously permits a user, such as a police or other law enforcement officer to remain focused on the vehicle or suspect and receive prompt feed back to allow the officer to make a quicker decision on the proper course of action to take.

In one aspect, the apparatus combines various technologies into a unified system that creates fast feedback and many other unique features that have not been brought together in such a manner as this before. This would allow the officer to stay focused on the situation or the suspect. The computer would give the feed back on the proper course of action to take. This would also provide a level of protection for the officer in that he or she would have a digital file to help back up what the officer is saying in a court of law. The system can also be used to coordinate other law enforcement activities, such as automatically instructing other officers in the vicinity to function as back-up.

One advantage to this apparatus is the time that it will save on giving feedback and/or decision-making instructions to the officer. It also has the potential to increase revenues to the city, municipalities, states, or other agencies that are using the system. As the system can be configured to generate a generally instant violation ticket for the offender, an example would be if the officer was sitting on a bridge overlooking a road and a vehicle sped by, the field device would take a photo of the vehicle record the license plate number and a photo of the driver. The field device would than using a high speed wireless connection or the like to send this info into the data base. The database could be configured to provide feedback to the officer regarding specific actions to take, such as if the vehicle had been stolen or the individual was wanted on an outstanding warrant the officer could receive instructions from the data base to pursue the vehicle. If the record of the vehicle and any owner of record was clean, then the officer using the field device could optionally issue a speeding ticket, such as by either pursuing the vehicle or by allowing the system to send a infraction notice to the individual through the mail. The latter option could potentially free the officer from taking time to fill out extensive paper work for the infraction. It will also allow for photos. For example, if the officer is called to the scene of the crime, the field device can be used to gather digital imaging of the crime in process or get feedback on the perpetrator. For instance digital imaging either taken with the field unit or uploaded into the field unit can be transmitted to the data base for automated or manual evaluation.

### BRIEF DESCRIPTION OF THE DRAWINGS

FIG. 1 is a view of an embodiment of a hand held device as disclosed herein in use;

FIG. 2 is a perspective view of the hand held device of FIG. 1; and

FIG. 3 is a schematic diagram of the interaction between the handheld device and a data base for use with the hand held device.

### DETAILED DESCRIPTION

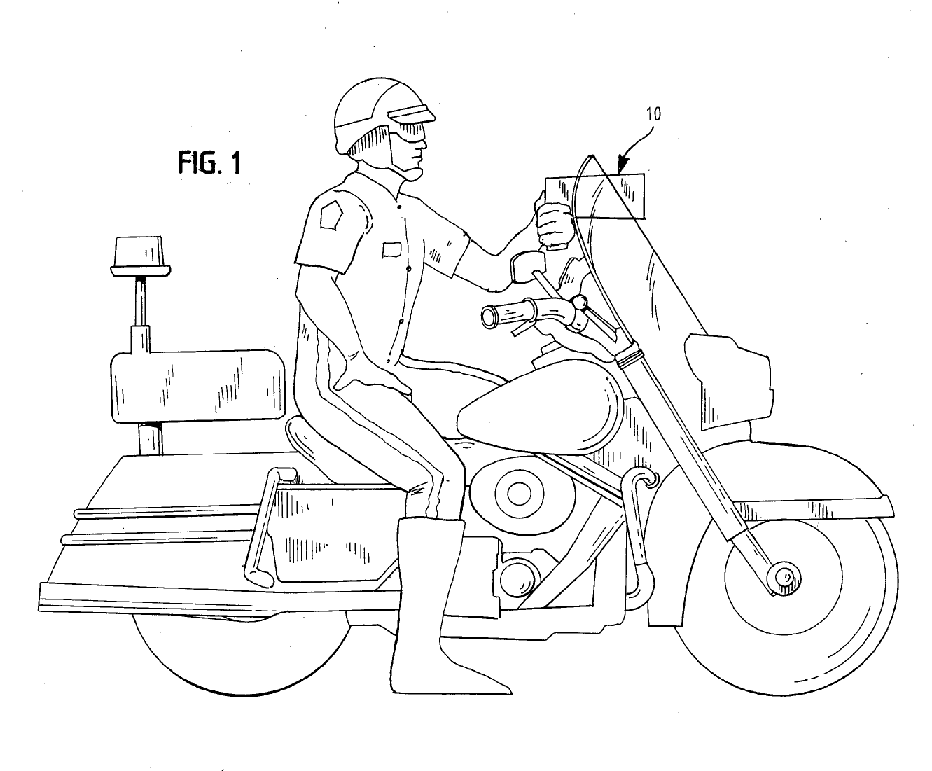

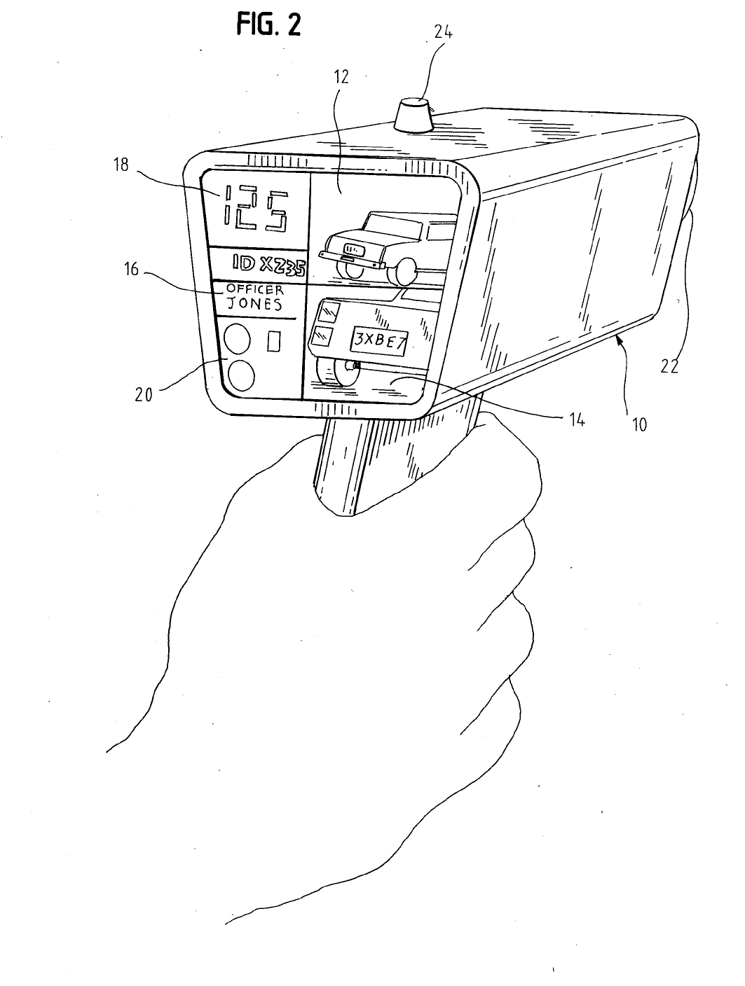

The apparatus may comprise a hand held field device that is networked or linked to a larger, integrated system that includes a central database. The field device 10, illustrated in FIGS. 1 and 2, can be utilized by an officer to perform a variety of functions. The field device 10 can be configured to record information about the user and a target vehicle. The field device 10 can also receive information from other field devices used by other officers, as well as from the central or other databases.

In the illustrated embodiment, the field device 10 includes a camera 22 for recording images of a target vehicle, person or location. The recorded images may be visually displayed on one or more screens 12 and 14 of the field device 10 for viewing by the officer or other user. For example, a large-view screen 12 may display a standard view of the image, while a zoom screen 14 may display a close-up view of identifying information, such as a building address or a license plate. The close-up view may be generated automatically by the field device, such as by keying in on recognizable text or numbers. The field device 10 may include a display 16 indicating identifying information about the user, such as an officer name and badge number. Another display 18 may be used to indicate the speed of a vehicle, such as generated by an integrated radar or other such device or generated by a detached radar or other such device linked to the field device 10. The field unit 10 may also include a user interface 20, including a user input. The user input may include knobs, buttons and the like for inputting information into the field device 10 or for navigating menus displayed on one or both of the screens 12 and 14. The user input may also include a keypad containing letters and/or numbers to permit more detailed information to be input into the field device 10. Examples of information that can be obtained by the field device 10 include digital images (such as of license plates, addresses, driver licenses or individuals), location (such as determined by GPS, cell triangulation or a preselected, fixed location), and other input means (such as a radar or other speed detector, a Geiger counter, manual keypad input or a bar code reader).

Information from the field device can be transmitted to the database or received therefrom through an integrated transmitter/receiver 24, which can function using suitable wireless technologies. For example, the field device 10 may be electronically connected to a computer or database using wireless technology so that it does not impede the officer's mobility. In another example, the field device 10, which may be a hand held device, may include a series of three or more digital cameras. Each of these cameras is programmed to do different things. For example, if an officer holding the field device 10 is observing a road and a speeding vehicle was approaching the field device would use its internal radar to detect and record the speed of the vehicle the first digital camera would photograph the scene including the vehicle and the surrounding, the second would focus in on the license which would instantly be scanned and entered into the data base this would give feedback to the officer on the small readout at the bottom of the field device, for example, ‘Wanted—DUI 3 outstanding warrants.” The officer would than know to pursue the individual. Or it might say “Stolen Vehicle—Pull Over.” The field device might also give feedback such as no record or warrants where in the Officer could than transmit a ticket, violation or warning to the offenders address.

Another example of how the field device 10 might be used would be at the scene of a crime to photograph suspects to provide the officer feedback such as, violent felon wanted in 6 states armed and dangerous, or suspected terrorist. A data base that coordinates and issues violations and our tickets. This system could also manage and print out Warrants as needed from the portable printer that is also part of the system we are calling the field device. This system could also print a violation or ticket in the event that state or national laws require that the officer is required to get a signature of the offender of the violation it would also allow for such things a the driver of the vehicle not actually owning the vehicle. The user input could be used to make modifications to any citation.

The advantages to the system are the ability of the officer to stay focused on the situation that they are involved in and yet receive feedback from a data base to help them gather information about the situation. It also allows for the officer to do much less paper work by generally instantly filling out the citation as well as logging it into a data base that the DA or judge can access the help determine the guilt or innocence of the perpetrator. It may also help in the capture of suspected terrorists and child adductors, and such as one of the cameras inside the field device will be programmed to focus on the face of the person or persons the officer is pointing the field device at. The information will than be scanned through the computer or database to give feedback as to the identification of the suspect, such as by using facial recognition software or the like.

The system is designed to lighten the burden of paper work for officers and other law enforcement personnel to permit them to prioritize their time. For example, an officer patrolling a reduced speed school zone could issue multiple tickets without pulling over a single vehicle. However, if the field device 10 receives information from the database that one of the license plates is registered to a sex offender, an instruction to pursue the vehicle could be received by the officer via the field device 10, which could be considered a priority over pursuing speed violators. The field device 10 is superior to many current radar systems, which may record merely the speed at which the vehicle is traveling. The field device 10 advantageously allows for officer interface with the data base with reduced requirements for entering the information into the computer by hand allowing due to automated interaction between the cameras and the database, allowing the officers to stay focused on the situation.

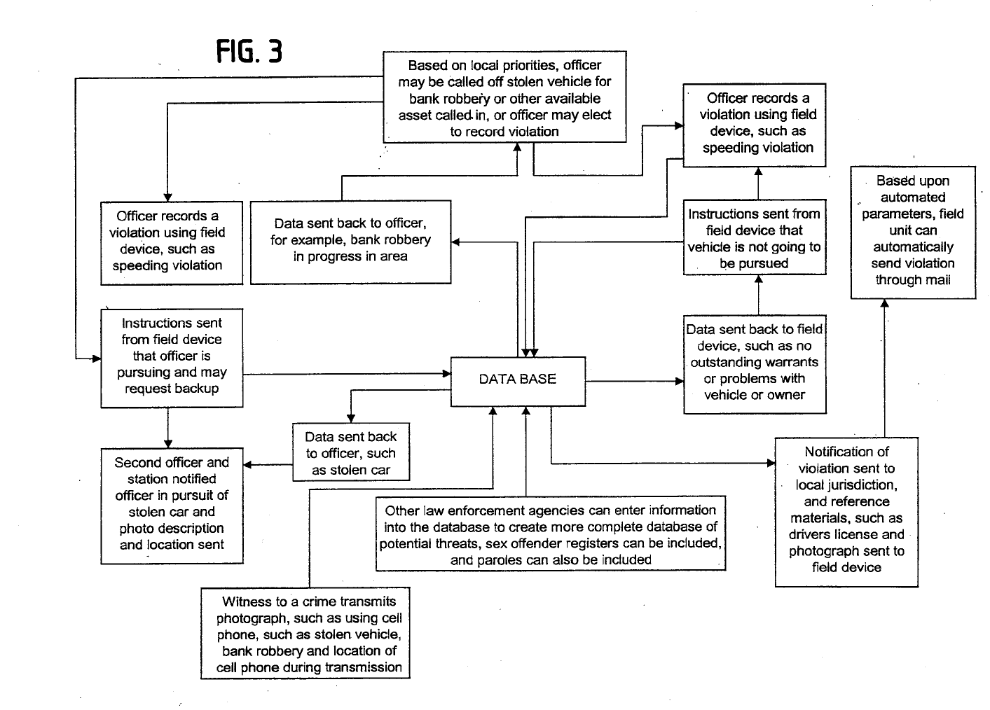

By way of example, interactions between an officer, the field device 10 and the database are illustrated in FIG. 3. The field device 10 can be used by an officer to gather vehicle or other information and transmit the same to the database. The database can evaluate the information, comparing it against outstanding warrants, information regarding stolen vehicles, sex offender registers, parole registers and the like. If a match is made, then the database can transmit an appropriate instruction, such as “Pursue and Pull Over” or “No Action Required” to the field device 10 for review by the officer. The officer can use the field unit 10 to acknowledge receipt of the instruction. If, for example, the instruction is “No Action Required”, then the officer can elect to issue a citation or turn attention to other vehicles.

Turning now to more of the details of the database, the database may include processing capabilities for evaluating information received from the field device 10 and transmitting appropriate instructions. The database of the system can be linked to other databases, such as international, federal, state and local law enforcement databases, insurance databases, etc. Examples of instructions can include taking no action, pursue and apprehend, pursue and investigate, pursue and wait for backup, issue citation, or do nothing. Various inputs into the database from the field device 10 can be prioritized by the processor based upon preset priority levels.

1. A system for obtaining field information, comparing the field information against other information and transmitting instructions to a user, the system comprising:
a portable field device for obtaining the field information using digital imaging, the field device having a camera for obtaining the digital imaging, a transmitter for wirelessly transmitting the field information, a receiver for wirelessly receiving the instructions, and a display for displaying the instructions; and
a processor for wirelessly receiving the field information from the portable field device, the processor being linked to at least one database for comparing the field information against other information in the at least one database, the processor being programmed with an algorithm for evaluating the field information against the other information in the at least one database and transmitting instructions to the field unit based upon predetermined criteria.

2. The system of claim 1, wherein the field device includes a radar gun.

3. The system of claim 1, wherein the field device includes at least two cameras, one of which is configured to record digital images of a license plate of a vehicle.

4. The system of claim 1, wherein the field device includes input means.

5. A method of determining an action for a law enforcement officer to take in response to traffic violation, the method comprising:
obtaining vehicular information using a portable field device;
wirelessly transmitting the vehicular information from the portable field device to a processor;
comparing the vehicular information with other information from a database using the processor to determine whether there is a match;
determining at least one of a plurality of preprogrammed instructions using the processor based upon the comparison of the vehicular information with the other information from the database and based upon predetermined criteria for different comparison results; and
wirelessly transmitting the at least one of the plurality of programmed instructions from the processor to the portable field device.

6. The method of claim 5, wherein the vehicular information includes at least one of a license plate image, a driver's license image, an image of a driver of a vehicle and an input of identification name or number into the field device.

7. The method of claim 5, including the step of wirelessly transmitting a different one of the at least one of the plurality of programmed instructions from the processor to a different portable field device.

8. The method of claim 5, including the step of wirelessly transmitting location information from the portable field device to the processor.
